(19) United States
(12) Patent Application Publication
(10) Pub. No.: US 2006/0071479 A1
(43) Pub. Date: Apr. 6, 2006

(54) Top-mounted container door system

(75) Inventors: William Randolph Roby, Marietta, GA (US); Hayden W. Newell, Boones Mill, VA (US); Harley N. Jacks, Harrington, DE (US); Bobby R. Hypes, Villa Rica, GA (US); John H. Sickafuse, New Castle, PA (US); Thomas J. Glasscock, Roanoke, VA (US); Jeff Sicilian, Toledo, OH (US); Patrick T. Torres, Acworth, GA (US); Anthony L. Rosa, Kennesaw, GA (US); Robert A. Helmick JR., Highland, MI (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: NORFOLK SOUTHERN CORPORATION, NORFOLK, VA (US)

(21) Appl. No.: 11/230,648

(22) Filed: Sep. 21, 2005

Related U.S. Application Data
(60) Provisional application No. 60/611,307, filed on Sep. 21, 2004.

(51) Int. Cl. E05C 3/04

(52) U.S. Cl. 292/218

(57) ABSTRACT

The present disclosure relates to boxcar, railcar, tractor trailer, ocean vessel, or other type shipping container, doors. Specifically, a top-mounted, sliding door is disclosed herein.

### RELATED APPLICATION

The subject application claims the benefit of U.S. Provisional Application No. 60/611,307 filed Sep. 21, 2004.

### BACKGROUND OF THE INVENTION

1. Field of the Invention

The present disclosure relates to a door for a boxcar, railcar, tractor trailer, ocean vessel, or other type shipping container. Specifically, a top-mounted, sliding, sealing door is disclosed herein.

2. Description of Related Art

Many existing shipping containers use some form of plug doors for access. One reason for the prevalent use of plug doors is their ability to seal the inside of the container from the weather. Common perception in the shipping industry is that other types of doors (e.g., sliding doors) do not sufficiently seal the inside of the container from the elements.

Typically, plug doors have numerous moving parts that must cooperate for the door to function properly. In practice, most shipping containers are subject to harsh environments and hard use. As a result of this wear-and-tear, moving parts on a plug door can fail to align or otherwise become difficult to operate. In addition, the number of moving parts used in a plug door increases the complexity, and thus, the cost of manufacturing, maintenance and repairs.

Another drawback of existing container door designs is that they can be difficult for operators to open and close. For example, a typical plug door can weigh as much as 1400 pounds and require 80 pounds of force to open.

In practice, shipping containers are often unloaded using equipment (e.g., forklifts, cranes, etc.). When this equipment is not skillfully operated, it can impact the door. Existing door designs often cannot withstand these impacts and become difficult to operate.

### SUMMARY OF THE INVENTION

The disclosed container door overcomes these and other drawbacks of existing systems. Accordingly, one disclosed embodiment comprises a top-mounted, sliding container door. The door uses brushes to seal some of the door opening. The door may also incorporate a rubber (or similar material) gasket on the doors to seal the door against water, dust or the like.

In addition, some embodiments of the door may incorporate an upper track for the door that encloses the roller mechanism. The bottom of the door may be reinforced to reduce damage and the bottom door wheel guide may be adjustable to compensate for damage or wear.

Other features may include extra bracing of the door, for strength and to prevent unauthorized opening and conveniently mounted handles to assist in opening the door. Other features and advantages of the door may be apparent from the following detailed description of the drawings.

### BRIEF DESCRIPTION OF THE DRAWINGS

FIG. 1 is an illustration of a one embodiment of a pair of top mounted doors shown in a closed position

FIG. 2 is a cross-sectional view of an embodiment of a top track.

FIG. 3 is an end-on view of one embodiment of an adjustable guide wheel for a top mounted door.

FIG. 4 is a illustration of one embodiment of seals that may be employed around the edges of the door and door opening.

### DETAILED DESCRIPTION OF THE DRAWING FIGURES

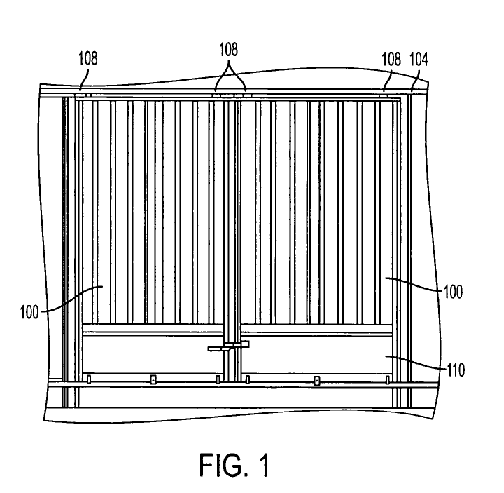

FIG. 1 is an illustration of a one embodiment pair of top mounted doors shown in a closed position. As shown, each door 100 may be mounted to travel along a top track 104. Any suitable number of rollers 108 may be included to enable doors 100 to travel along top track 104. For example, FIG. 1 shows two rollers 108 per each door 100, however, more or less rollers 108 may be used as desired.

Doors 100 may also have a reinforced portion 110 that is designed to resist damage from forklifts and other loading/unloading machinery. Reinforced portion 110 may be made of any suitable material to absorb some of the stresses and shocks encountered by the door. For example, the reinforced portion 110 may comprise steel, aluminum or other metals and alloys, composite materials (e.g., fiberglass, Kevlar™, etc.), plastics, or other suitable material.

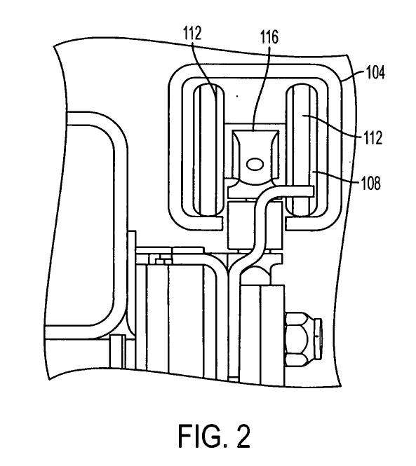

FIG. 2 is a cross-sectional view of an embodiment of a top track 104. Top track 104 may be designed in any suitable shape to allow doors 100 to travel along the track. For example, top track 104 may comprise an substantially enclosed channel defining a space in which roller 108 may travel. One advantage of an enclosed top track 104, is that the enclosed space helps to prevent the rollers 108 from being knocked off the track.

As shown in FIG. 2, one embodiment of rollers 108 may comprise a number of wheels 112 mounted on axel 116. Of course, other mechanisms to enable sliding of the doors 100 may also be used. For example, roller bearings, or the like may be used to facilitate motion of the door along top track 104.

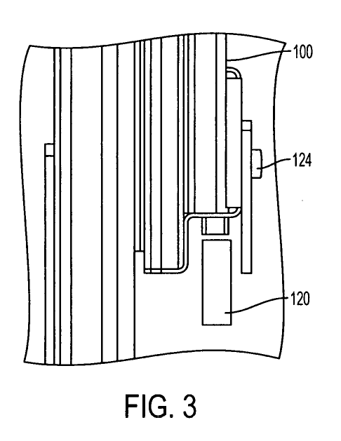

FIG. 3 is an end-on view of one embodiment of an adjustable guide wheel 120 for a top mounted door 100. As shown, it may be desirable in some embodiments to include a guide wheel 120 to facilitate movement of the door 100 along the floor of the container. Although a guide wheel 120 is shown in FIG. 3, other motion aides may be used. For example, a roller or other type of bearing may be used to facilitate motion of the door 100.

FIG. 3 also illustrates one embodiment of an adjustment mechanism 124 that enables adjustment of the height of the guide wheel 102 with respect to the container floor. Among other things, adjustment mechanism 124 allows the position of guide wheel 120 to be adjusted to accommodate irregularities in the container floor or other potential impediments to door 100 operation. As shown in FIG. 3, the adjustment mechanism 124 may comprise an adjustable bracket, screw mount or some other type of positionable mount.

In addition, guide wheel 120 may be configured to cooperate with a track, ramp or other guide to facilitate movement of the door 100 along the floor of the container. For example, a ramp may be positioned in a advantageous location to allow door 100 to be lifted off of track 104 for maintenance or other purposes.

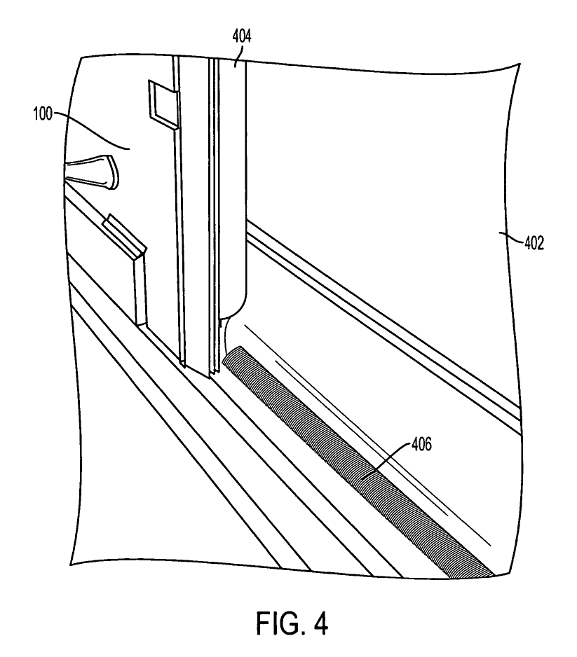

Some embodiments may comprise sealing members to seal the perimeter of the doors 100. FIG. 4 is a illustration of one embodiment of seals that may be employed around the edges of the door and door opening. As noted above, one drawback of existing sliding doors is that they are often ineffective at sealing the container from outside elements (e.g., rain, dust, snow, etc.). Sealing members 404, 406 may be positioned at advantageous locations along the door 100 to facilitate sealing off the inside of the container 402. For example, sealing members 404, 406 may be positioned along the top and bottom of door 100 and along the left and right edges of doors 100. Thus, when closed, the sealing members contact the container wall, the adjacent door 100, or each other to substantially seal the door 100. Of course, other sealing arrangements are possible.

In some embodiments, sealing members 404, 406 may comprise brush seals (shown at 406). For example, nylon brushes or the like may be implemented. Other sealing members may also be used. For example, sealing members 404, 406 may comprise rubber gaskets, or other flexible, water resistant material (shown at 404).

Another feature of some embodiments of the top-mounted door 100 is to include bracing members near the bottom of the door 100. In addition to strengthening door 100, these bracing members may provide attachment points to enable hooks or the like for tying down loads or facilitating opening of the doors 100.

Yet another feature of some embodiments of the top mounted door 100 is the inclusion of advantageous leverage points and handles to facilitate operation of the door. For example, vertically mounted handles may be provided to facilitate manual operation of the door 100.

In one embodiment, suitable for railcar use, the top-mounted door 100 may comprise a lighter structure (e.g., approximately 930 pounds) than a conventional plug door, that is correspondingly easier to operate (e.g., less than 50 pounds of opening force). Furthermore, door 100 may be constructed out of any suitable material. For example, door 100 may comprise steel, aluminum, other alloys or metals, composite materials, plastics, or any other suitable material appropriate for the shipping application. In addition, the above described top mounted door 100 is resistant to damage and provides good sealing of the interior of the container. Other advantages and features will be apparent to those of ordinary skill in the art.

Embodiments of the above-described top mounted door 100 may be incorporated into newly manufactured containers or retrofitted onto existing containers.

Although the present invention has been described in terms of particular embodiments, it is not limited to these embodiments. Alternative embodiments and modifications which would still be encompassed by the invention may be made by those skilled in the art, particularly in light of the foregoing teachings. Therefore, this invention is defined by the following claims and is intended to cover any alternative embodiments, modifications or equivalents which may be within the spirit and scope of the claimed invention.

What is claimed is:

1. A shipping container door assembly comprising:
a door panel comprising a top side, a bottom side, a left side and a right side;
a roller mounted near the top side of the door panel;
a substantially enclosed track, mounted at a position in proximity to the top side of the door panel when the door panel is mounted on the shipping container, and shaped to form an inner channel to receive the roller inside the substantially enclosed track and thereby enable the door panel to move along the substantially enclosed track;
a door guide positioned near the bottom side of the door to facilitate movement of the door panel along the substantially enclosed track, wherein the position of the door guide is adjustable with respect to the bottom side of the door panel;
a reinforcement section positioned near the bottom of the door panel and formed to resist damage to the bottom of the door panel; and
seal members positioned along the top, bottom, left and right sides of the door panel.

2. The shipping container door of claim 1 wherein the seal members further comprise gaskets.

3. The shipping container door of claim 2 wherein the gaskets further comprise rubber gaskets.

4. The shipping container door of claim 1 wherein the seal members further comprise brush members located at a position proximate to the top side and the bottom side of the door panel when the door panel is in a closed position.

5. The shipping container door of claim 4 wherein the brush members further comprise sealing brushes.

6. The shipping container door of claim 5 wherein the sealing brushes further comprise nylon brushes.

7. The shipping container door of claim 1 further comprising brace members located near the bottom side of the door panel.

8. The shipping container door of claim 7 wherein the brace members further comprise attachment points.

9. The shipping container door of claim 1 further comprising handles mounted on the door panel to facilitate manual operation of the door.

10. The shipping container door of claim 9 wherein the handles are mounted in a substantially vertical orientation.

11. A method of providing a shipping container with a door, the method comprising:
providing a door panel comprising a top side, a bottom side, a left side and a right side;
providing a roller mounted near the top side of the door panel;
providing a substantially enclosed track, mounted at a position in proximity to the top side of the door panel when the door panel is mounted on the shipping container, and shaped to form an inner channel to receive the roller inside the substantially enclosed track and thereby enable the door panel to move along the substantially enclosed track;
providing a door guide positioned near the bottom side of the door to facilitate movement of the door panel along the substantially enclosed track, wherein the position of the door guide is adjustable with respect to the bottom side of the door panel;
providing a reinforcement section positioned near the bottom of the door panel and formed to resist damage to the bottom of the door panel; and
providing seal members positioned along the top, bottom, left and right sides of the door panel.

12. The method of claim 11 wherein the seal members further comprise gaskets.

13. The method of claim 12 wherein the gaskets further comprise rubber gaskets.

14. The method of claim 11 wherein the seal members further comprise brush members located at a position proximate to the top side and the bottom side of the door panel when the door panel is in a closed position.

15. The method of claim 14 wherein the brush members further comprise sealing brushes.

16. The method of claim 15 wherein the sealing brushes further comprise nylon brushes.

17. The method of claim 11 further comprising brace members located near the bottom side of the door panel.

18. The method of claim 17 wherein the brace members further comprise attachment points.

19. The method of claim 11 further comprising handles mounted on the door panel to facilitate manual operation of the door.

20. The method of claim 19 wherein the handles are mounted in a substantially vertical orientation.
